(19) United States
(12) Patent Application Publication
(10) Pub. No.: US 2010/0288114 A1
(43) Pub. Date: Nov. 18, 2010

(54) Apparatus For Protecting A Target From An Explosive Warhead

(76) Inventor: Konstantinos N. Soukos, Larissa (GR)

Correspondence Address: BAKER BOTTS LLP, 2001 ROSS AVENUE, 6TH FLOOR, DALLAS, TX, 75201-2980, US

(21) Appl. No.: 12/023,596

(22) Filed: Jan. 31, 2008

(30) Foreign Application Priority Data
Jul. 13, 2007 (GR) 20070100456

(51) Int. Cl. F41H 5/02; B23P 11/00; B23P 17/00

(52) U.S. Cl. 89/36.02; 29/525.01; 29/525.14; 89/903; 89/918

(57) ABSTRACT

A web includes strings and connectors that form ogive damagers. An ogive damager has three or more strings and three or more connectors. The connectors connect the strings to form a closed loop having an area that allows at least a tip of an ogive of a rocket to pass through the area. Each ogive damager is configured to damage the rest of the rocket.

### RELATED APPLICATION

This application claims benefit under 35 U.S.C. §119(a) of Greek Patent Application Serial No. 20070100456, entitled “FLEXIBLE WEB FOR COUNTERING ROCKET PROPELLED GRENADES,” filed Jul. 13, 2007, by Konstantinos N. Soukos.

### TECHNICAL FIELD

This invention relates generally to the field of defense systems and more specifically to an apparatus for protecting a target from an explosive warhead.

### BACKGROUND

An explosive warhead detonates upon impact with a target. A rocket-propelled grenade (RPG) comprises a rocket equipped with an explosive warhead. A launcher propels the rocket towards the target.

### SUMMARY OF THE DISCLOSURE

In accordance with the present invention, disadvantages and problems associated with previous techniques for protecting a target may be reduced or eliminated.

According to one embodiment, a web includes strings and connectors that form ogive damagers. An ogive damager has three or more strings and three or more connectors. The connectors connect the strings to form a closed loop having an area that allows at least a tip of an ogive of a rocket to pass through the area. Each ogive damager is configured to damage the rest of the rocket.

Certain embodiments of the invention may provide one or more technical advantages. A technical advantage of one embodiment may be that a web protects a target from an explosive warhead by disarming the warhead. Another technical advantage of one embodiment may be that the web is safe and easy to manufacture and use relative to other weapon defense systems. Another technical advantage of one embodiment may be that the web does not block vision. Another technical advantage of one embodiment may be that the web is relatively discreet. Another technical advantage of one embodiment may be that the web is flexible and may be shaped to protect the target.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIGS. 1A and 1B illustrate one example of a web according to one embodiment;

FIG. 2 illustrates a perspective view of the web of FIG. 1 at the instant of impact of a rocket-propelled grenade;

FIGS. 3A and 3B illustrate another example of a web according to one embodiment;

FIGS. 4A and 4B illustrate an example of a connector that may be used with a web according to one embodiment;

FIGS. 5A through 5D illustrate views of the connector of FIGS. 4A and 4B;

FIGS. 6A and 6D illustrate views of the web of FIG. 1; and

FIGS. 7 through 9 illustrate examples of webs with different connectors.

### DETAILED DESCRIPTION OF THE DRAWINGS

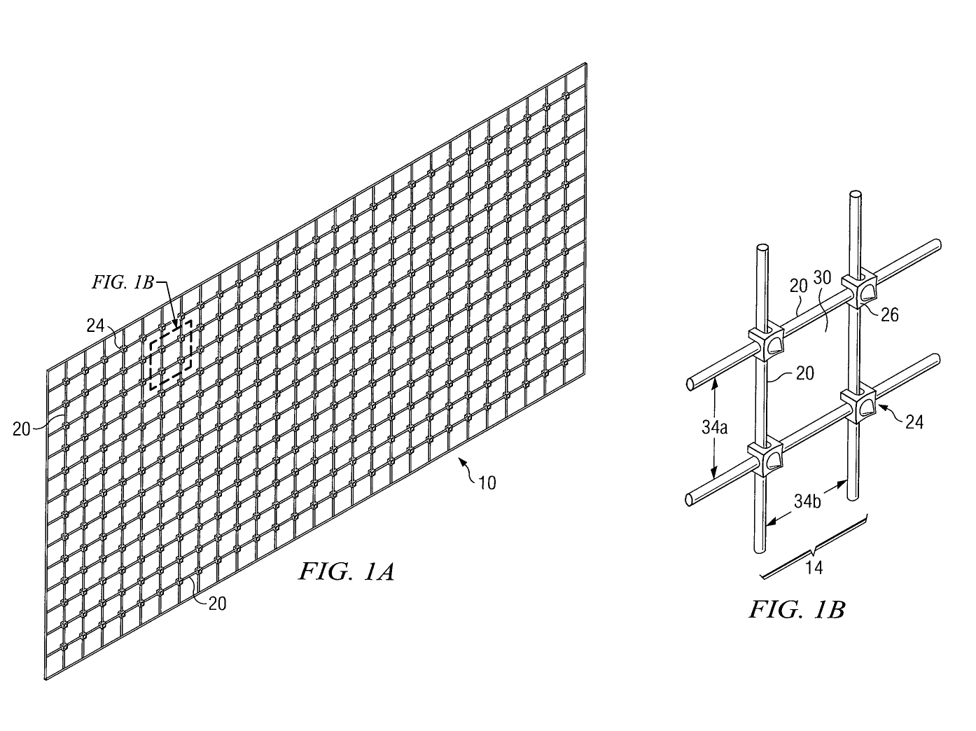

Embodiments of the present invention and its advantages are best understood by referring to FIGS. 1 through 9 of the drawings, like numerals being used for like and corresponding parts of the various drawings.

FIGS. 1A and 1B illustrate one example of a web 10. A system of one or more webs 10 may protect a target against an explosive projectile, such as a rocket-propelled grenade. A rocket-propelled grenade comprises a rocket equipped with an explosive warhead that detonates upon impact with a target. In one example, the nose of the rocket is formed by an ogive, which may be a secant metallic surface. The tip of the ogive may have an impact sensor (such as a piezoelectric crystal) that detects impact and sends a detonation command through electrical conductors to a detonator. The detonator detonates the explosive warhead in response to the detonation command.

One or more webs 10 may be placed between a target and a rocket-propelled grenade. The front side of web 10 faces the rocket-propelled grenade, and the back side faces the target. In one embodiment, one web 10 may placed in front of the target. In another embodiment, two or more webs 10 may layered in front of the target.

In the illustrated embodiment, web 10 includes strings 20 and connectors 24 coupled as shown. A “string” 20 may refer to a string 20 between the ends of web 10 or to a portion of string 20 between connectors 24. Strings 20 may have any suitable dimensions. For example, the diameter of a string 20 can be approximately equal to or greater than 1, 2, 5, 10, 15, or 20 millimeters (mm), for example, in the range of 2 to 10 mm. Strings 20 may be flexible, and may have any suitable tensile strength, such as a yield strength of greater than 500, 750, 1000, 1500, 2000, 3000, 4000, or 5000 megapascals (MPa).

Strings 20 may comprise any suitable material, such as metal, metallic alloy, synthetic material, and/or other suitable material. Examples of suitable material include steel, basalt, carbon, carbon nanotubes, ultra high molecular weight polyethylene (UHMWPE) (high modulus polyethylene (HMPE) or high performance polyethylene (HPPE)) (such as DYNEEMA), and/or other suitable material.

Connectors 24 maintain the relative positions of strings 20, and are described in more detail with reference to FIGS. 4A and 4B. Strings 20 may be coupled to connectors 24 in any suitable manner. For example, strings 20 may be welded (such as silver welded) to connectors 24. As another example, connectors 24 may be tightened to hold strings 20.

Strings 20 and connectors 24 form ogive damagers 14. An ogive damager 14 includes strings 20 and connectors 24 that form a closed loop with an area 30. FIG. 1B illustrates one ogive damager 14. In one embodiment, ogive damager 14 allows the tip of an ogive to enter area 30 without touching strings 20 and/or connectors 24 in order to avoid initiating a detonation command. Ogive damager 14, however, can damage the rest of the ogive and/or rocket.

Area 30 of the closed loop may have any suitable shape and size. In one embodiment, area 30 is a polygon, such as a triangle, square, rectangle, parallelogram, pentagram, hexagon, or other suitable n-sided shape. In one embodiment, area 30 may be sufficiently large to allow at least the tip of an ogive to enter area 30, and may be sufficiently small to allow strings 20 and/or connectors 24 bordering area 30 to damage the ogive. The tip may be allowed to enter area 30 without touching strings 20 and/or connectors 24 in order to avoid initiating a detonation command. As an example, distance 34 between adjacent strings 20 may be greater than 20, 30, 40, 50, 55, 75, or 100 mm. As another example, a diameter of area 30 between adjacent strings 20 may be greater than 20, 30, 40, 50, 55, 60, 75, or 100 mm. The diameter of a polygon may be measured as the length of the longest line between the edges of the polygon that that passes through the center of the polygon.

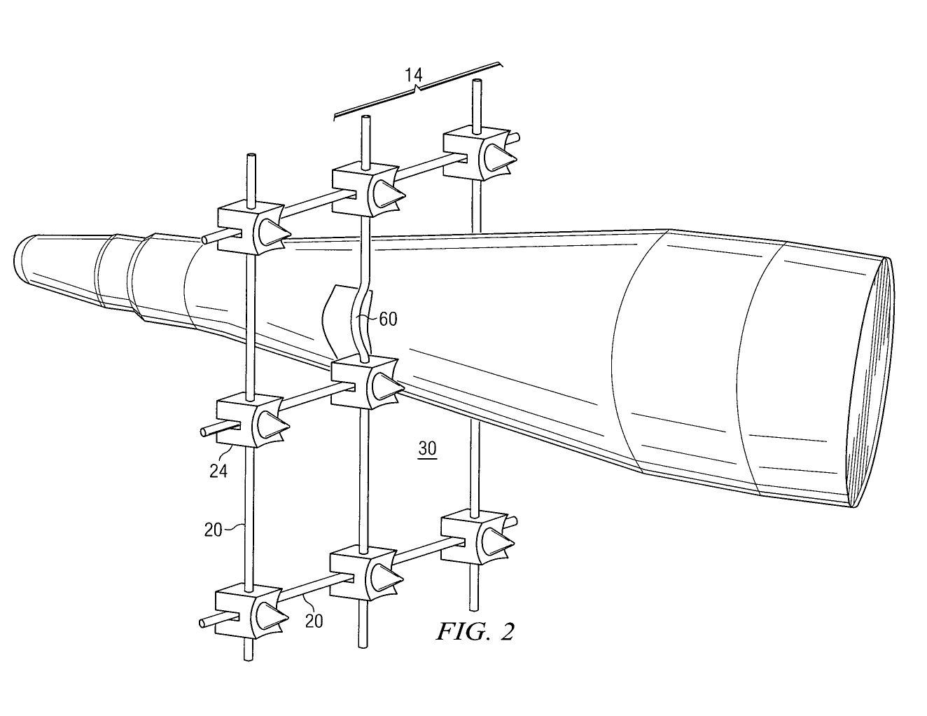

FIG. 2 illustrates a perspective view of web 10 at the instant of impact of a rocket-propelled grenade. When a rocket-propelled grenade strikes web 10 with high momentum, connectors 24 and/or strings 20 of ogive damager 14 apply a reactive force to the grenade. The force may cause damage 60, such as mechanical deformation, to the ogive. The force may damage, for example, short circuit, electrical conductors that transfer the detonation command to the detonator, preventing detonation of the warhead.

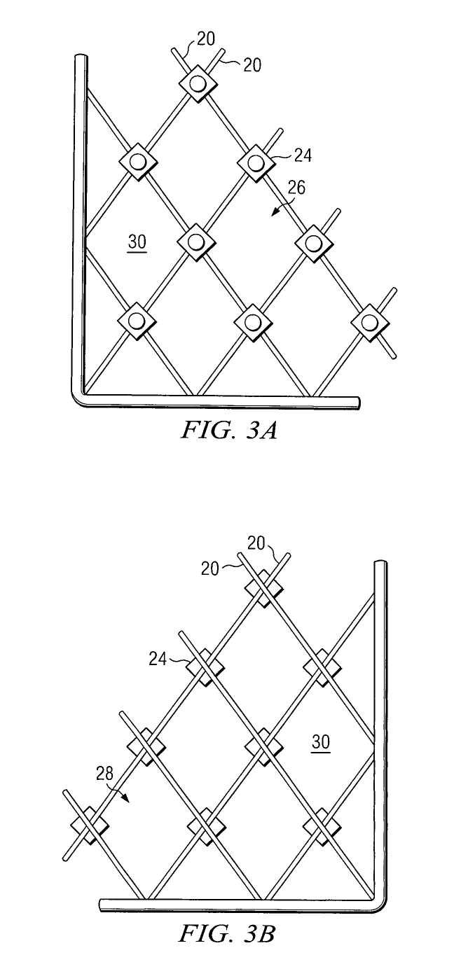

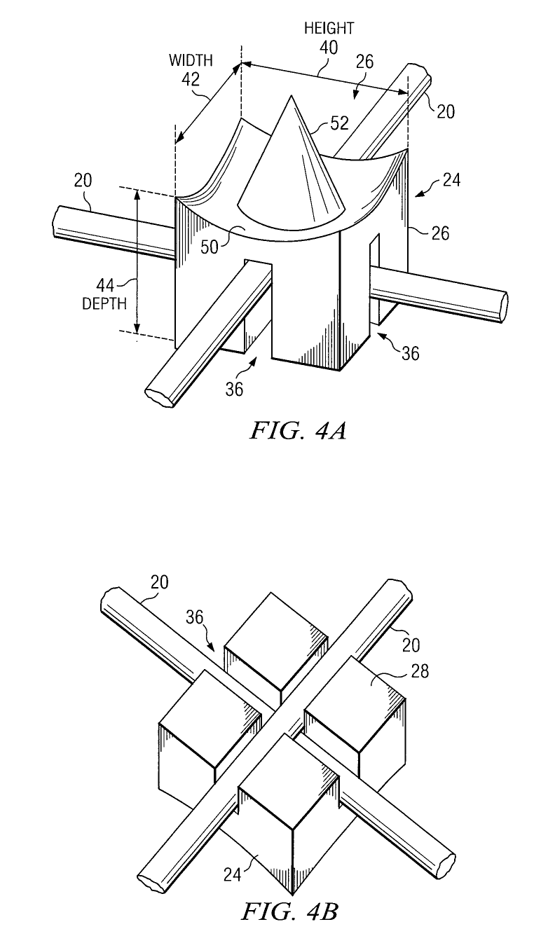

FIGS. 3A and 3B illustrate another example of web 10. In the example, areas 30 formed by adjacent strings 20 are rhombuses. FIG. 3A illustrates a front view of web 10, and FIG. 3B illustrates a back view of web 10.

FIGS. 4A and 4B illustrate an example of connector 24 that may be used with web 10 of FIG. 1. A front surface 26 of connector 24 faces the front of web 10 towards the rocket grenade, and a back surface 28 faces the back of web 10 towards the target. Front surface 26 of a connector 24 may the same as or different from back surface 28 of the connector 24. Front surfaces 26 of different connectors 24 may the same as or different from each other. Back surfaces 28 of different connectors 24 may the same as or different from each other.

A connector 24 may have any suitable dimensions to accommodate strings 20. For example, height 40 may be greater than 1, 5, 10, 20, or 30 mm, such as 6 to 30 mm. Width 42 may be greater than 1, 5, 10, 20, or 30 mm, such as 6 to 30 mm. Depth 44 may be greater than 1, 5, 10, 20, or 30 mm, such as 6 to 30 mm.

A connector 24 may have any suitable tensile strength, such as a yield strength of greater than 500, 750, 1000, 1500, 2000, 3000, 4000, or 5000 MPa. A connector 24 may comprise any suitable material, such as metal, metallic alloy, synthetic material, and/or other suitable material. Examples of suitable material include steel.

Front surface 26 may be designed to damage the ogive of a rocket. In the illustrated example, front surface has a concave surface 50 with a spike 52 disposed substantially in the center of concave surface 50. Spike 52 has a substantially conical shape.

Back surface 28 has transverse indentations 36 shaped similarly to the shape of the intersection of strings 20. In the embodiment, strings 20 intersect each other at the vertical axis of symmetry of connector 24. The depth of indentation 26 may be greater than the sum of the diameters of the intersected strings 20 and less than depth 44 of connector 24. For example, the depth may be at least 3 mm greater than the sum of the diameters of strings and at least 3 mm less than depth 44. The width may be sized to accommodate strings 20.

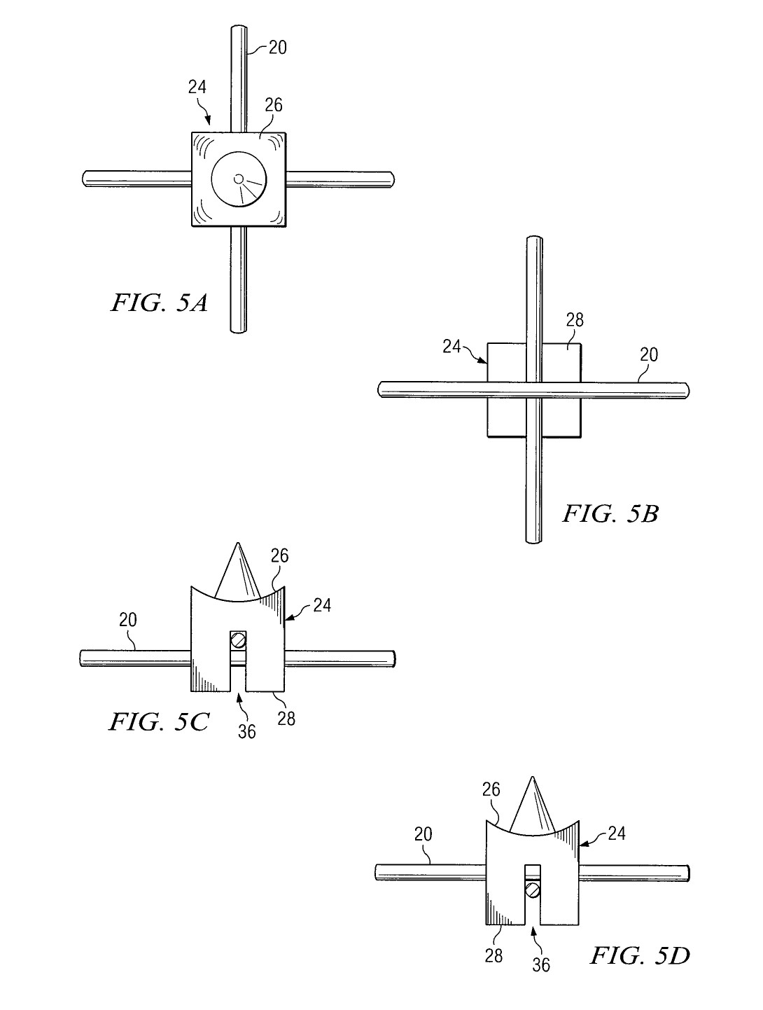

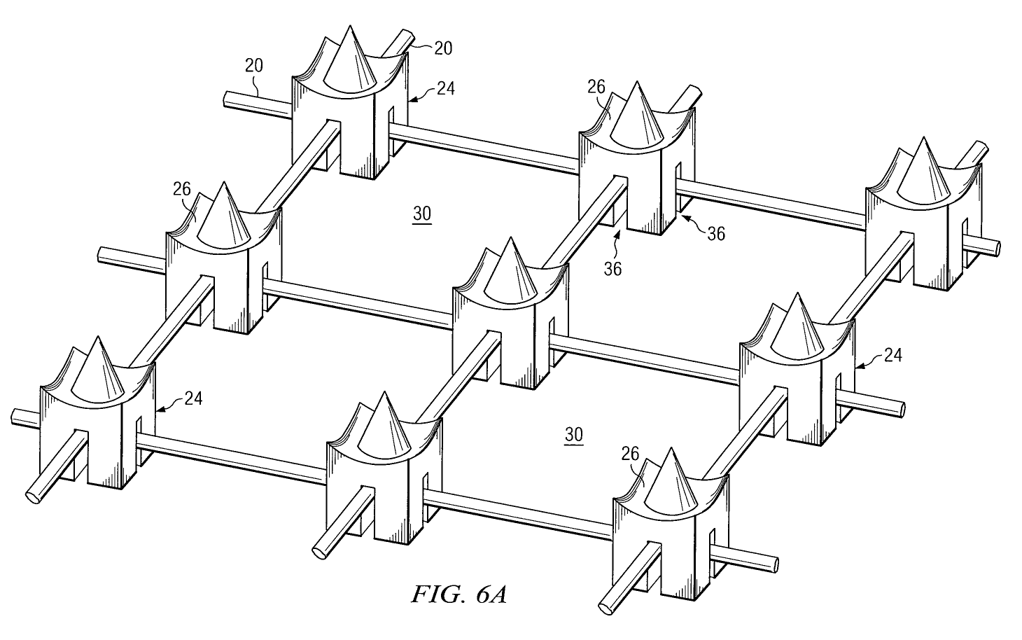

FIGS. 5A through 5D illustrate views of the example of connector 24 of FIGS. 4A and 4B. FIG. 5A illustrates a front view of connector 24 and strings 20. FIG. 5B illustrates a back view of connector 24 and strings 20. FIG. 5C illustrates a side view of connector 24 and strings 20. FIG. 5D illustrates another side view of connector 24 and strings 20.

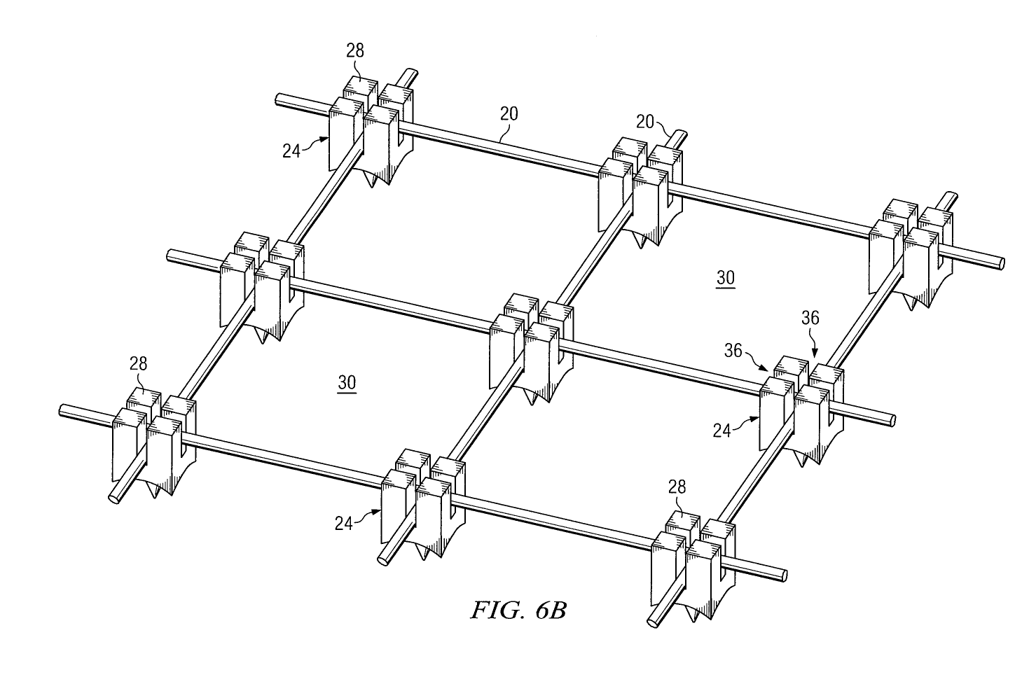

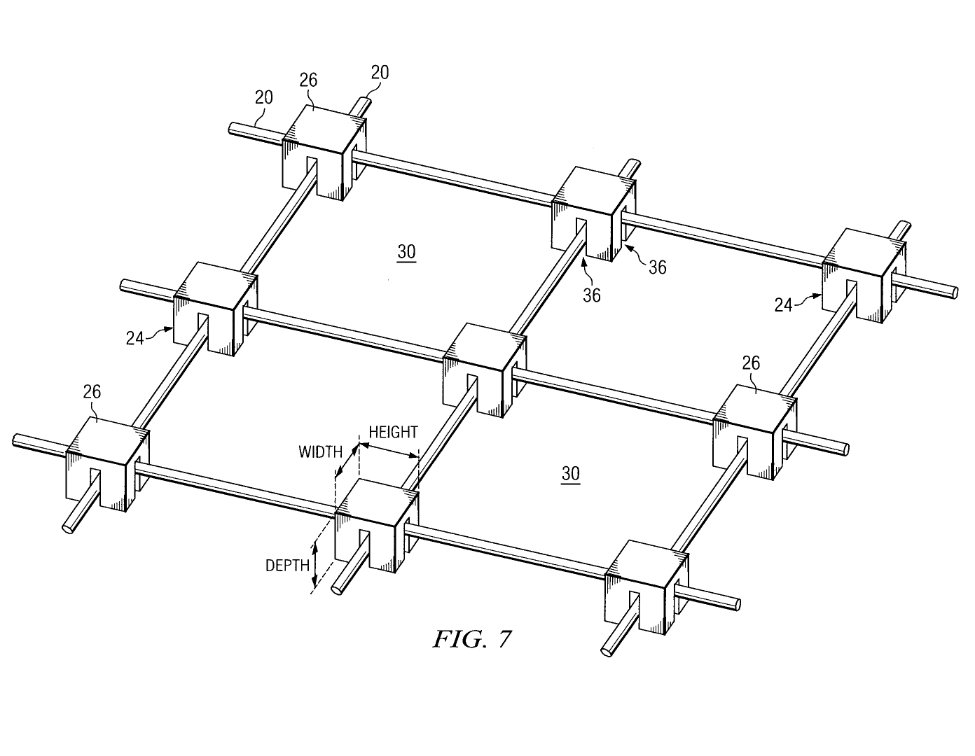

FIGS. 6A and 6D illustrate views of the example of web 10 of FIG. 1. FIG. 6A illustrates a perspective from view of web 10, and FIG. 6B illustrates a perspective back view of web 10.

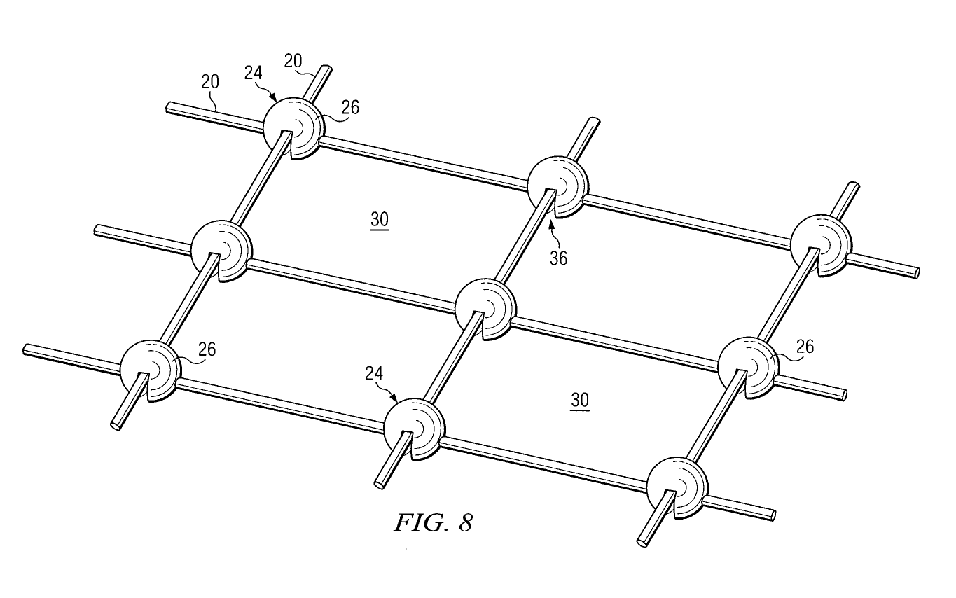

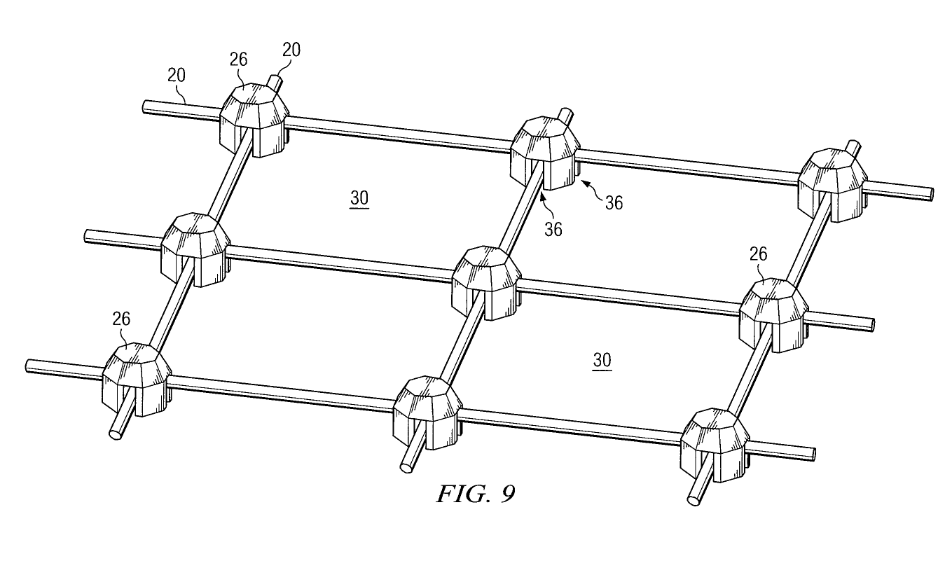

FIGS. 7 through 9 illustrate examples of webs 10 with different connectors 24. FIG. 7 illustrates connectors 24, where each has a front surface 26 that is substantially flat. FIG. 8 illustrates connectors 24, where each is substantially spherical. FIG. 9 illustrates connectors 24, where each has a substantially prismatic shape.

Modifications, additions, or omissions may be made to web 10 without departing from the scope of the invention. The components of web 10 may have any suitable number, size, and shape. As used in this document, “each” refers to each member of a set or each member of a subset of a set.

Certain embodiments of the invention may provide one or more technical advantages. A technical advantage of one embodiment may be that a web protects a target from an explosive warhead by disarming the warhead. Another technical advantage of one embodiment may be that the web is safe and easy to manufacture and use relative to other weapon defense systems. Another technical advantage of one embodiment may be that the web does not block vision. Another technical advantage of one embodiment may be that the web is relatively discreet. Another technical advantage of one embodiment may be that the web is flexible and may be shaped to protect the target.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. An apparatus comprising:
a plurality of strings;
a plurality of connectors; and
a plurality of ogive damagers formed from the plurality of strings and the plurality of connectors, each ogive damager comprising:
three or more strings of the plurality of strings; and
three or more connectors of the plurality of connectors, the three or more connectors connecting the three or more strings to form a closed loop having an area that allows at least a tip of an ogive of a rocket to pass through the area, the each ogive damager configured to damage the rest of the rocket.

2. The apparatus of claim 1, the three or more strings having a yield strength of greater than 1500 megapascals (MPa).

3. The apparatus of claim 1, the area having a diameter greater than 55 millimeters (mm).

4. The apparatus of claim 1, the area having a polygon shape.

5. The apparatus of claim 1, the damage preventing detonation of a warhead transported by the rocket.

6. The apparatus of claim 1, one or more connectors of the three or more connectors having a front surface configured to damage the rest of the rocket.

7. The apparatus of claim 1, one or more connectors of the three or more connectors having a front surface comprising a concave surface.

8. The apparatus of claim 1, one or more connectors of the three or more connectors having a front surface comprising a spike.

9. The apparatus of claim 1, one or more connectors of the three or more connectors having a spherical shape.

10. The apparatus of claim 1, one or more connectors of the three or more connectors having a prismatic shape.

11. The apparatus of claim 1, one or more connectors of the three or more connectors having a back surface with two or more indentations, an indentation configured to receive a string.

12. An method comprising:
performing the following to form each ogive damager of a plurality of ogive damagers of a web, the each ogive damager comprising three or more strings and three or more connectors:
attaching the three or more strings to the three or more connectors; and
forming a closed loop from the attached three or more connectors and three or more strings, the closed loop having an area that allows at least a tip of an ogive of a rocket to pass through the area, the each ogive damager configured to damage the rest of the rocket.

13. The method of claim 12, the attaching the three or more strings to the three or more connectors further comprising:
disposing a string of the three or more strings within an indentation of a back surface of a connector of the three or more connectors.

14. The method of claim 12, the attaching the three or more strings to the three or more connectors further comprising:
welding a string of the three or more strings to a back surface of a connector of the three or more connectors.

15. The method of claim 12, the attaching the three or more strings to the three or more connectors further comprising:
tightening a connector of the three or more connectors to hold a string of the three or more strings.

16. An apparatus comprising:
a plurality of strings;
a plurality of connectors; and
a plurality of ogive damagers formed from the plurality of strings and the plurality of connectors, each ogive damager comprising:
four strings of the plurality of strings; and
four connectors of the plurality of connectors, the four connectors connecting the four strings to form a closed loop having an parallelogram area that allows at least a tip of an ogive of a rocket to pass through the area, the each ogive damager configured to damage the rest of the rocket

17. The apparatus of claim 15, the four strings having a yield strength of greater than 1500 megapascals (MPa).

18. The apparatus of claim 15, one or more connectors of the four connectors having a front surface configured to damage the rest of the rocket.

19. The apparatus of claim 15, one or more connectors of the four connectors having a front surface comprising a spike.

20. The apparatus of claim 15, one or more connectors of the four connectors having a back surface with two or more indentations, an indentation configured to receive a string.
